(19) United States
(12) Patent Application Publication
(10) Pub. No.: US 2009/0243864 A1
(43) Pub. Date: Oct. 1, 2009

(54) WARNING DEVICE AGAINST FILTER MATERIAL BLOCKING FOR AQUARIUM

(76) Inventor: Yu-Chin WANG, Taipei (TW)

Correspondence Address: SINORICA, LLC, 2275 Research Blvd., Suite 500, ROCKVILLE, MD, 20850, US

(21) Appl. No.: 12/058,687

(22) Filed: Mar. 29, 2008

(51) Int. Cl. G08B 21/00

(52) U.S. Cl. 340/623

(57) ABSTRACT

A warning device against blocking of filter material for an aquarium, it mainly has a receiving case having therein a battery chamber for receiving at least a battery, and having a triggering switch electrically connecting with an indicating lamp installed in the receiving case; and the warning device has a detector which has a link mechanism, one end of the link mechanism is connected with the triggering switch, the other end is provided with a float bowl extending into the filter tank of the aquarium to detect the level of water. When in blocking, the water level rises to raise the float bowl to actuate the triggering switch to turn on the indicating lamp, thus a warning effect is obtained.

### BACKGROUND OF THE INVENTION

1. Field of the Invention

The present invention relates to a warning device, and especially to a warning device against blocking of a filter tank for an aquarium.

2. Description of the Prior Art

In feeding living things in an aquarium, cleanness of water is very important, because cleanness may influence superiority and inferiority of the living things in the water; if the water is seriously bad, it may make dead of the living things in the water. Therefore, the aquarium must be equipped with a filter tank for filtering dirt in the water to keep cleanness of the water.

Although providing of the filter tank can keep cleanness of the water, after long term using, the filter tank is subjected to being blocked, and a user is not easy to find this and is unable to clean up or change filter material in due time, thus the filtering function of the filter material get lost, and improvement is wanted.

### SUMMARY OF THE INVENTION

The present invention gives a design against the problem resided in the prior art to provide a warning device against blocking of filter material for an aquarium, the device is structurally simple and cost low, and can effectively emit warning against blocking of the filter tank to notice a user to clean up or change filter material in time.

The warning device against blocking of filter material for an aquarium provided by the present invention mainly has a receiving case having therein a battery chamber for receiving at least a battery, and having a triggering switch electrically connecting with an indicating lamp installed in the receiving case; and the warning device has a detector which has a link mechanism, one end of the link mechanism is connected with the triggering switch, the other end is provided with a float bowl extending into the filter tank of the aquarium to detect the level of water. When in blocking, the water level rises to raise the float bowl to actuate the triggering switch to turn on the indicating lamp, thus a warning effect is obtained.

The present invention will be apparent in its structure and action after reading the detailed description of the preferred embodiments thereof in reference to the accompanying drawings.

### BRIEF DESCRIPTION OF THE DRAWINGS

FIG. 1 is a perspective schematic view showing the warning device provided by the present invention installed in an aquarium;

FIG. 2 is an anatomic perspective view of the present invention;

FIG. 3 is a perspective view of the present invention after assembling;

FIG. 4 is a sectional view of the present invention;

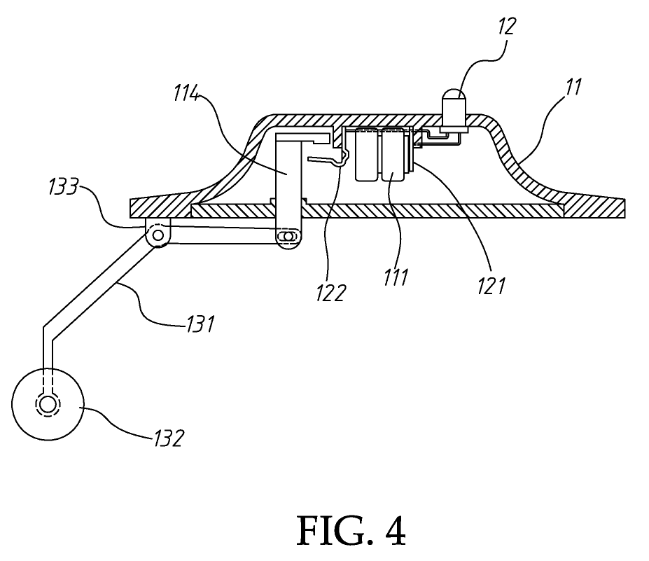

FIG. 5 is a sectional schematic view showing the action of the present invention;

FIG. 6 is an anatomic perspective view of a second embodiment of the present invention;

FIG. 7 is a perspective view of the second embodiment of the present invention after assembling;

FIG. 8 is a sectional view of the second embodiment of the present invention.

### DETAILED DESCRIPTION OF THE PREFERRED EMBODIMENT

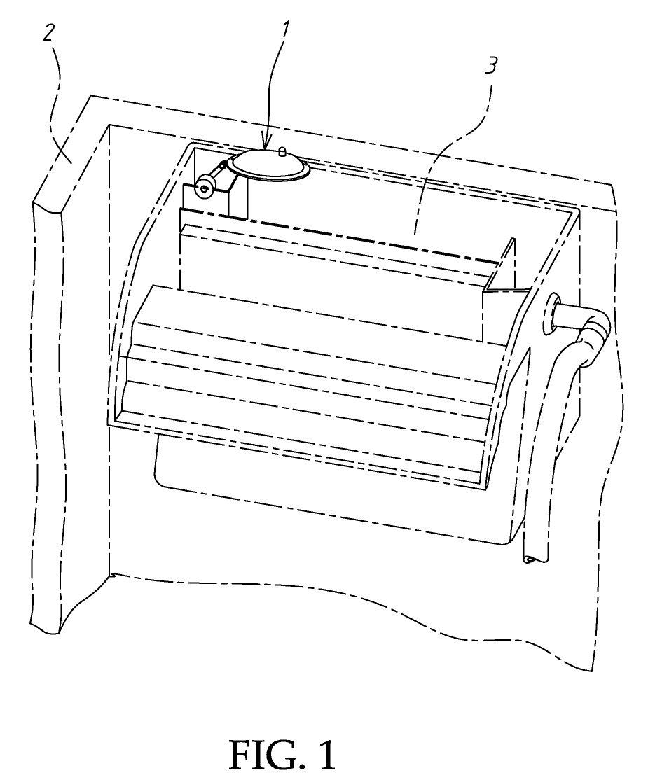

Referring to FIG. 1, in which the warning device 1 against blocking of filter material for an aquarium 2 provided by the present invention is installed on a filter tank 3 for the aquarium 2 to indicate the state of blocking.

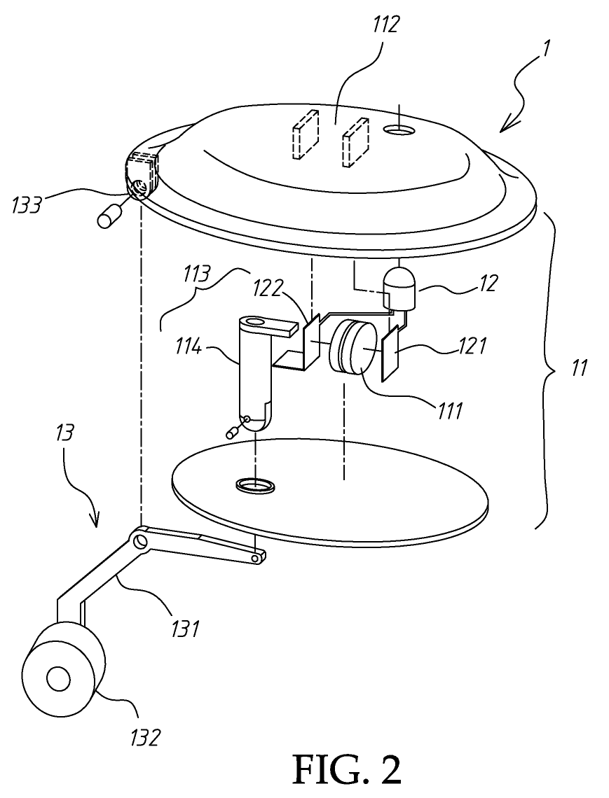

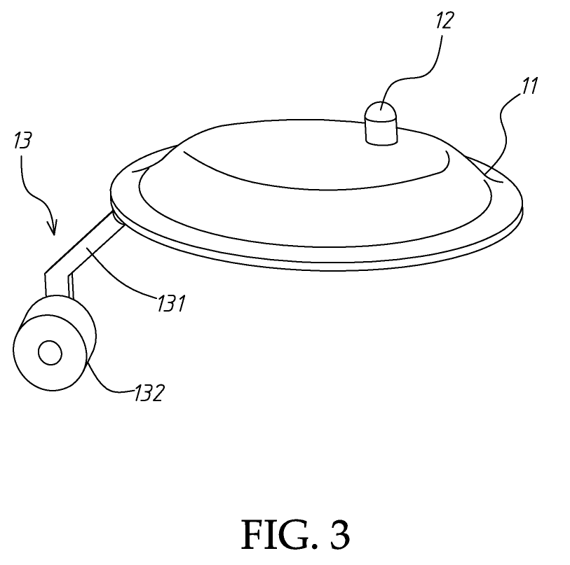

Further referring to FIGS. 2 and 3, the warning device 1 against blocking of filter material for the aquarium 2 of the present invention comprises mainly a receiving case 11, an indicating lamp 12 and a detector 13.

The receiving case 11 is installed on the filter tank 3 for the aquarium 2, and is in the shape of a fly saucer, it is provided in an upper space of it with a battery chamber 112 for receiving at least a battery 111 for supplying electric power, and has a triggering switch 113 for controlling turning on/off of the electric power. The indicating lamp 12 is provided on the surface of the receiving case 11, and is electrically connected with the triggering switch 113; the indicating lamp 12 can be a light emitting diode (LED), a tailing end of its first pin 121 is extended to a positive electrode of the battery 111, while a tailing end of its second pin 122 is extended to be adjacent to a negative electrode of the battery 111 and composes the triggering switch 113 together with an up/down movable triggering rod 114. The triggering rod 114 will contact the tailing end of the second pin 122, this tailing end also will contact the negative electrode of the battery 111 to thereby turn on and lighten the indicating lamp 12.

The detector 13 has a link mechanism 131, one end of the link mechanism 131 is connected with the triggering switch 113 (i.e., the bottom end of the triggering rod 114), the other end is provided with a float bowl 132 extending into the filter tank 3 of the aquarium 2 to detect the level of water. The link mechanism 131 further has a pivot portion 133 fixed on the bottom of the receiving case 11, in order that when the float bowl 132 is raised, an end of the link mechanism 131 in connection with the triggering switch 113 is lowered.

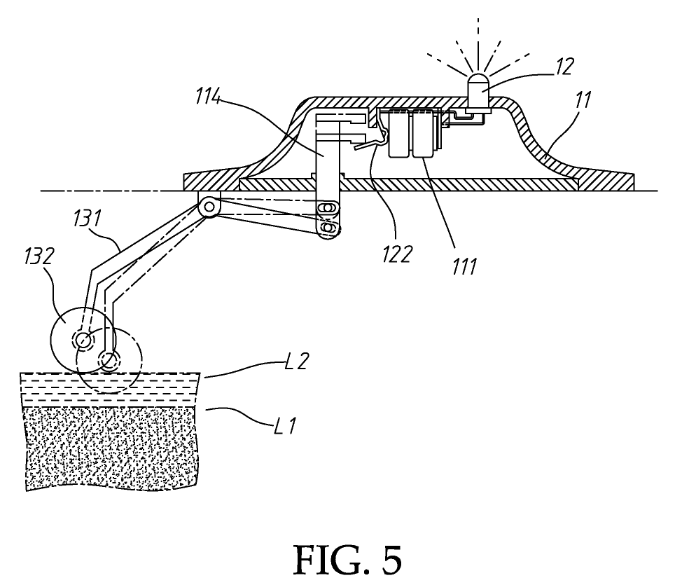

FIG. 5 shows the action of the present invention, when in blocking of the filter tank 3 for the aquarium 2 that raises the level of water from L1 to L2 as shown in the drawing, the float bowl 132 is pushed upwards to make the link mechanism 131 contact the triggering switch 113, thereby the triggering rod 114 is lowered, and the tailing end of the second pin 122 of the indicating lamp 12 contacts the negative electrode of the battery 111 to thereby turn on and lighten the indicating lamp 12, thus a warning effect is obtained.

The warning device 1 against blocking of the filter material for the aquarium 2 provided by the present invention is structurally simple and cost low, and can effectively emit warning against blocking of the filter material to notice a user to clean up or change filter material, and cleanness of water in the aquarium 2 can thus be assured.

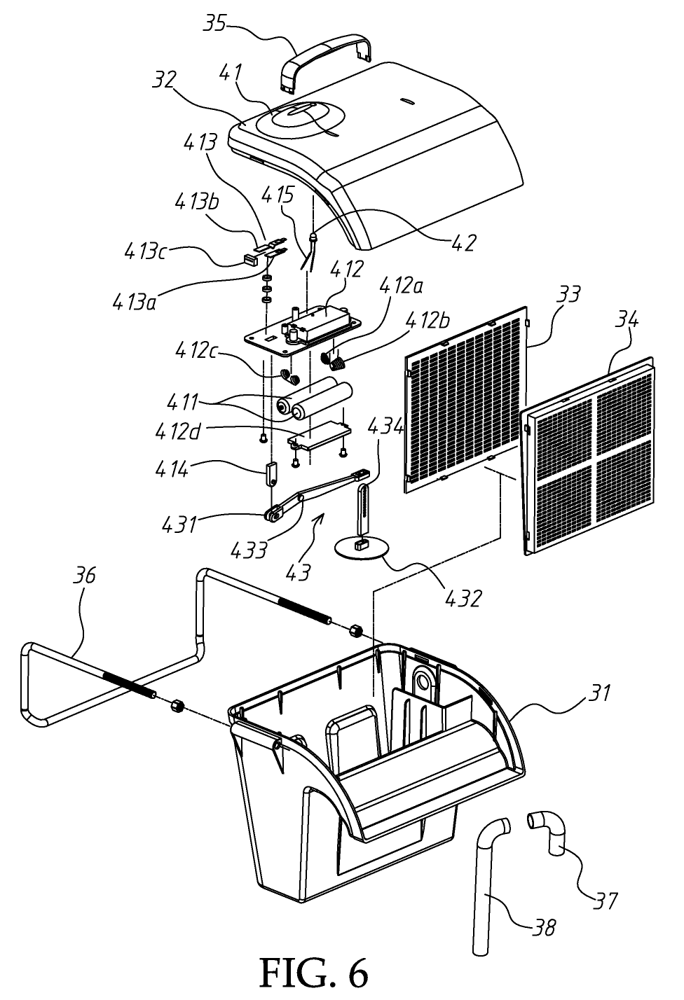

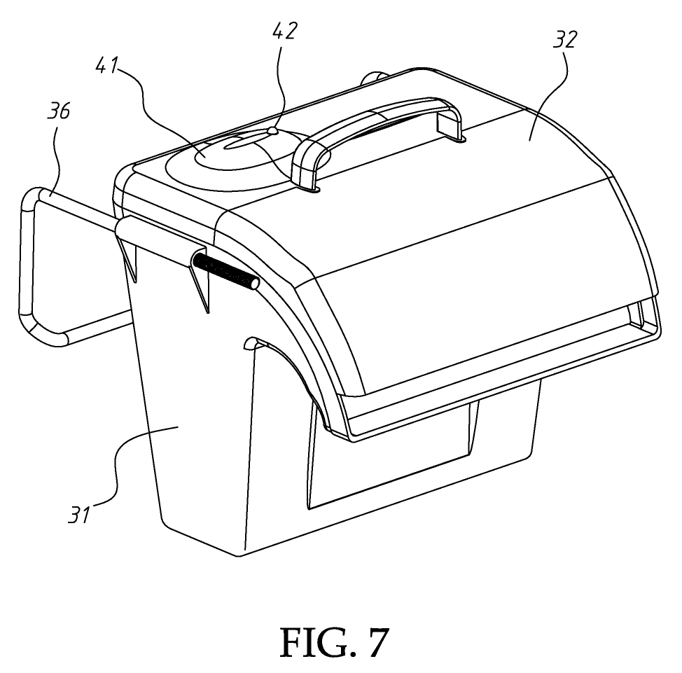

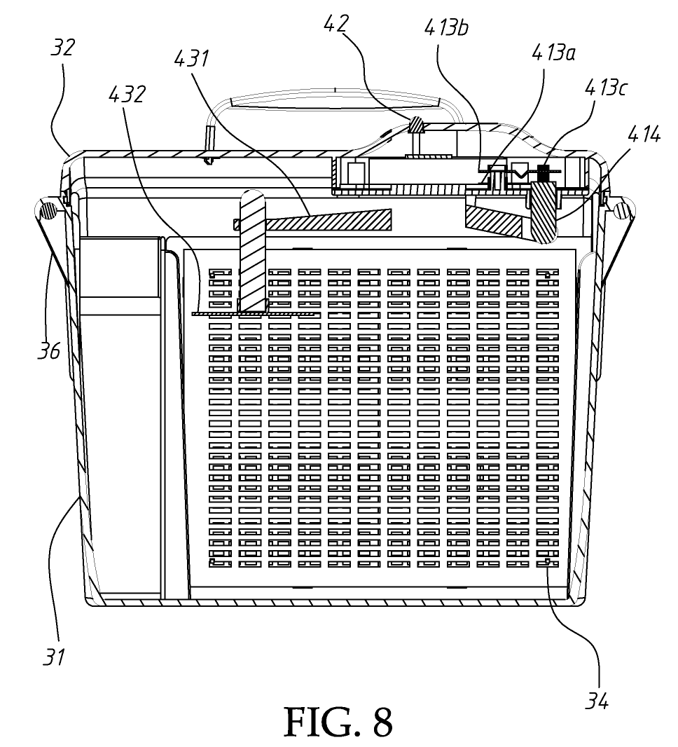

And more, FIGS. 6 to 8 show a second embodiment of the present invention, wherein the filter tank 3 has a main body 31 and an upper cover 32. The main body 31 receives therein a front filter lid 33 and a rear filter lid 34; the upper cover 32 is connected on its top surface with a handle 35 for opening. And a hanging hook 36 is assembled with and extends outwards from the main body 31 for the convenience of hanging on an aquarium. The main body 31 further is connected with a bending pipe connector 37 and a bent pipe 38 for access of water.

A receiving case 41 of the warning device is provided on the upper cover 32 for mounting thereon an indicating lamp 42 and a detector 43.

The receiving case 41 has therein a battery chamber 412 for receiving two batteries 411 to supply electric power, and has a triggering switch 413 for controlling turning on/off of the electric power. The indicating lamp 42 is provided on the surface of the receiving case 41, and is electrically connected with the triggering switch 413 via a connecting line 415. The battery chamber 412 is provided with a positive electrode 412a in contact with the two batteries 411, and is provided with a negative electrode 412b and a connecting piece 412c for connecting the positive electrode 412a with the negative electrode 412b of the two batteries 411, in order that the two electrodes can be electrically connected with each other. The triggering switch 413 is composed of a positive-electrode spring sheet 413a, a negative-electrode spring sheet 413b and a spring sheet supporting member 413c, an up/down movable triggering rod 414 can push the spring sheet supporting member 413c to selectively make contact or separate of the positive-electrode spring sheet 413a with/from the negative-electrode spring sheet 413b for circuit connecting/breaking. The battery chamber 412 is provided therebelow a battery-chamber lid 412d for the convenience of changing the batteries 411 when the latter are exhausted.

The indicating lamp 42 is a light emitting diode (LED); its pin is extended to a positive electrode of the batteries 411 via a wire of the connecting line 415, while a tailing end of its second pin is extended to the triggering switch 413 via the other wire of the connecting line 415.

The detector 43 has a crank 431, one end of the crank 431 is connected with the bottom end of the triggering rod 414 of the triggering switch 413, the other end is slipped over the upper portion of a supporting member 434 of a floating disk 432, the lower end of the supporting member 434 is connected with the floating disk 432 which extends into a filter tank 3 for the aquarium to detect the level of water. The crank 431 further is provided with a pivot portion 433, in order when the floating disk 432 rises, the crank 431 is lowered together with an end connecting with the triggering switch 413.

The second embodiment of the present invention is similar with the first one in action; however, it acts by the function of the lever system formed by the crank 431. When not in use, the upper spring sheet supporting member 413c on the triggering rod 414 makes separation of the negative-electrode spring sheet 413b from the positive-electrode spring sheet 413a to turn off the indicating lamp 42. When the filter system is blocked during water pumping to raise the level of water, the floating disk 432 gives its function under the action of the lever system of the crank 431 to lower the triggering rod 414, and under the action of the spring sheet supporting member 413c, the negative-electrode spring sheet 413b contacts the positive-electrode spring sheet 413a to turn on the indicating lamp 42 for alarming.

In conclusion, according to the description disclosed above, the present invention provides an improved novel structure that meets the element requirement for a patent. While the embodiment given is only for illustrating preferred embodiments of the present invention, and not for giving any limitation to the scope of the present invention; it will be apparent to those skilled in this art that various modifications or changes without departing from the spirit of this invention shall also fall within the scope of the appended claims.

1. A warning device against blocking of filter material for an aquarium, said warning device comprises:
a receiving case installed on a filter tank for said aquarium, it is provided therein with a battery chamber for receiving at least a battery for supplying electric power, and has a triggering switch for controlling turning on/off of electric power;
an indicating lamp provided on a surface of said receiving case, it is electrically connected with said triggering switch; and
a detector having a link mechanism, one end of said link mechanism is connected with said triggering switch, other end is provided with a float bowl extending into said filter tank of said aquarium to detect level of water;
when in blocking of said filter tank for said aquarium that raises said level of water, said float bowl is pushed upwards to make said link mechanism contact said triggering switch to thereby turn on and lighten said indicating lamp, thus a warning effect is obtained.

2. The warning device against blocking of filter material for an aquarium as claimed in claim 1, wherein said receiving case is in a shape of a fly saucer, said battery chamber is provided in an upper space of said receiving case.

3. The warning device against blocking of filter material for an aquarium as claimed in claim 1, wherein said indicating lamp is a light emitting diode (LED), a tailing end of a first pin thereof is extended to a positive electrode of said battery, while a tailing end of a second pin thereof is extended to be adjacent to a negative electrode of said battery and composes said triggering switch together with an up/down movable triggering rod; said triggering rod contacts said tailing end of said second pin, said tailing end also contacts said negative electrode of said battery to thereby turn on and lighten said indicating lamp.

4. The warning device against blocking of filter material for an aquarium as claimed in claim 1, wherein said link mechanism has a pivot portion fixed on a bottom of said receiving case, in order that when said float bowl is raised, an end of said link mechanism in connection with said triggering switch is lowered.

5. The warning device against blocking of filter material for an aquarium as claimed in claim 1, wherein said filter tank has a main body and an upper cover, said main body receives therein at least a front filter lid and at least a rear filter lid, said upper cover is connected on its top surface with a handle for opening; and a hanging hook is assembled with and extends outwards from said main body for convenience of hanging on an aquarium, said main body further is connected with a bending pipe connector and a bent pipe for access of water.

6. The warning device against blocking of filter material for an aquarium as claimed in claim 5, wherein said receiving case of said warning device is provided on said upper cover.

7. The temperature detecting heater with an indicating structure for an aquarium as claimed in claim 5, wherein said indicating lamp is electrically connected with said triggering switch via a connecting line, said battery chamber is provided with a positive electrode in contact with two batteries, and is provided with a negative electrode and a connecting piece for connecting said positive electrode with said negative electrode of said two batteries, in order that said two electrodes are electrically connected with each other.

8. The warning device against blocking of filter material for an aquarium as claimed in claim 6, wherein said triggering switch has of a positive-electrode spring sheet, a negative-electrode spring sheet and a spring sheet supporting member, an up/down movable triggering rod is adapted to pushing said spring sheet supporting member to selectively make contact or separate of said positive-electrode spring sheet with/from said negative-electrode spring sheet for circuit connecting/breaking.

9. The warning device against blocking of filter material for an aquarium as claimed in claim 6, wherein said battery chamber is provided therebelow a battery-chamber lid for convenience of changing said batteries when said batteries are exhausted.

10. The warning device against blocking of filter material for an aquarium as claimed in claim 6, wherein said detector has a crank, one end of said crank is connected with a bottom end of a triggering rod of said triggering switch, other end is slipped over an upper portion of a supporting member of a floating disk, a lower end of said supporting member is connected with said floating disk which extends into said filter tank for said aquarium to detect said level of water; said crank further is provided with a pivot portion, in order when said floating disk rises, said crank is lowered together with an end connecting with said triggering switch.
